(19) United States
(12) Patent Application Publication
(10) Pub. No.: US 2026/0281981 A1
(43) Pub. Date: Sep. 17, 2026

(54) WIRELESS CONTROL DEVICE, COMMUNICATION SYSTEM, PROGRAM, AND METHOD FOR CONTROLLING WIRELESS CONTROL DEVICE

(71) Applicant: SONY GROUP CORPORATION, TOKYO (JP)

(72) Inventors: REN SUGAI, TOKYO (JP); YUSUKE TANAKA, TOKYO (JP)

(21) Appl. No.: 18/877,912

(22) PCT Filed: Apr. 27, 2023
(86) PCT No.: PCT/JP2023/016599

§ 371 Date: Dec. 20, 2024

(30) Foreign Application Priority Data
Jun. 29, 2022 (JP) 2022104392

(51) Int. Cl. H04W 72/0446; H04L 5/00; H04W 72/0453

(52) U.S. Cl. CPC H04W 72/0446; H04W 72/0453; H04L 5/0005

(57) ABSTRACT

Interference is suppressed in a wireless control device that performs multiplexing by a NOMA system. A wireless communication system includes a first communication terminal and a second communication terminal. The first communication terminal transmits a predetermined signal subjected to non-orthogonal multiple access (NOMA). The second communication terminal includes a control unit that determines a transmission position in at least one of a frequency domain or a time domain of a NOMA signal multiplexed to the signal subjected to NOMA by a NOMA system on the basis of a random value.

### TECHNICAL FIELD

The present technology relates to a wireless control device. Specifically, this relates to a wireless control device that performs multiplexing, a communication system, a program, and a method for controlling a wireless control device.

### BACKGROUND ART

Conventionally, in a wireless local area network (LAN), when a communication terminal transmits a signal, a delay may occur due to transmission standby. In order to reduce this delay, a non-orthogonal multiple access (NOMA) system may be used in which a wireless station multiplexes another signal while transmitting a signal to another wireless station in such a manner that interference is partially allowed. For example, a wireless station to which a random power offset is applied in a subframe in which NOMA is used has been proposed (refer to, for example, Patent Document 1).

### CITATION LIST

### Patent Document

Patent Document 1: Japanese Unexamined Patent Application Publication No. 2019-520728

### SUMMARY OF THE INVENTION

### Problems to be Solved by the Invention

In the above-described conventional technology, by applying a random power offset, asynchronous communication that does not require transmission timing or the like to be matched in advance can be performed. However, in the above-described conventional technology, there is a possibility that signals more than expected are multiplexed and interference increases, and a reception side cannot decode the signals.

The present technology has been made in view of such a situation, and an object thereof is to suppress interference in a wireless control device that performs multiplexing by a NOMA system.

### Solutions to Problems

The present technology is achieved for solving the above-described problem, and a first aspect thereof is a wireless control device including a control unit that determines a transmission position in at least one of a frequency domain or a time domain of a NOMA signal multiplexed to a signal subjected to NOMA by a non-orthogonal multiple access (NOMA) system on the basis of a random value. This brings about an effect of suppressing interference.

Furthermore, in the first aspect, the control unit may acquire reference position information indicating a predetermined reference position in at least one of a frequency domain or a time domain included in a signal transmitted from another wireless device, and determine the transmission position on the basis of the reference position information. This brings about an effect of determining the transmission position on the basis of the reference position.

Furthermore, in the first aspect, the control unit may determine, as the transmission position, a position shifted from the reference position by an amount based on the random value along at least one of a time axis or a frequency axis. This brings about an effect of suppressing interference.

Furthermore, in the first aspect, the control unit may determine, as the transmission position, a position shifted by an amount based on a random value within a predetermined range along at least one of a time axis or a frequency axis. This brings about an effect of determining a random position within a predetermined range.

Furthermore, in the first aspect, the signal may include range information indicating the range. This brings about an effect of specifying a random position within a predetermined range indicating the range information.

Furthermore, in the first aspect, the signal may include information indicating a mode in which communication of the NOMA system is performed. This brings about an effect that communication of the NOMA system is started.

Furthermore, in the first aspect, the signal subjected to NOMA may include information indicating that multiplexing to the signal by the NOMA system is allowed. This brings about an effect that multiplexing by the NOMA system is performed.

Furthermore, in the first aspect, the signal may include step information indicating a unit of shifting from the reference position. This brings about an effect that the step information is extracted from a notification signal.

Furthermore, in the first aspect, the signal subjected to NOMA may include step information indicating a unit of shifting from the reference position. This brings about an effect that the step information is extracted from the signal subjected to NOMA.

Furthermore, in the first aspect, the other wireless device may be a base station, and the signal may be a response signal of the base station to a predetermined polling signal. This brings about an effect that step information can be acquired even if there is a hidden terminal.

Furthermore, in the first aspect, the reference position may include a reference position common to all communication terminals connected to the base station. This brings about an effect that a position shifted from a common reference position is acquired.

Furthermore, in the first aspect, the reference position may include a reference position common to a predetermined number of communication terminals in a predetermined group. This brings about an effect that a position shifted from the reference position of the group is acquired in the group.

Furthermore, in the first aspect, the reference position may include a reference position individually allocated to a predetermined communication terminal. This brings about an effect that a position shifted from an individual reference position is acquired for each communication terminal.

Furthermore, in the first aspect, the reference position may include a reference position allocated to the hidden terminal to which the signal subjected to NOMA does not reach. This brings about an effect that the position shifted from the individual reference position is acquired in the hidden terminal.

Furthermore, a second aspect of the present technology is a wireless communication system including a first communication terminal that transmits a predetermined signal subjected to NOMA, and a second communication terminal including a control unit that determines a transmission position in at least one of a frequency domain or a time domain of a NOMA signal multiplexed to the signal subjected to NOMA by a NOMA system on the basis of a random value. This brings about an effect of suppressing interference in the wireless communication system.

### BRIEF DESCRIPTION OF DRAWINGS

FIG. 1 is a diagram illustrating a configuration example of a wireless communication system according to a first embodiment of the present technology.

FIG. 2 is a block diagram illustrating a configuration example of a communication terminal according to the first embodiment of the present technology.

FIG. 3 is a sequence diagram illustrating an example of a communication method of the wireless communication system according to the first embodiment of the present technology.

FIG. 4 is a diagram for illustrating a countermeasure against interference according to the first embodiment of the present technology.

FIG. 5 is a diagram illustrating a configuration example of a frame in a notification signal from a base station according to the first embodiment of the present technology.

FIG. 6 is a diagram illustrating an example of a reference position in the notification signal according to the first embodiment of the present technology.

FIG. 7 is a diagram illustrating an example of step information in the notification signal according to the first embodiment of the present technology.

FIG. 8 is a diagram illustrating a configuration example of a frame in a signal subjected to NOMA from a terminal subjected to NOMA according to the first embodiment of the present technology.

FIG. 9 is a diagram illustrating a configuration example of a frame in a first variation of the first embodiment of the present technology.

FIG. 10 is a diagram illustrating a configuration example of a frame in a second variation of the first embodiment of the present technology.

FIG. 11 is a sequence diagram illustrating an example of a communication method of a wireless communication system according to a second embodiment of the present technology.

FIG. 12 is a diagram illustrating a configuration example of a notification signal according to the second embodiment of the present technology.

FIG. 13 is a block diagram illustrating a configuration example of a wireless communication device used as a first application example.

FIG. 14 is a block diagram illustrating a configuration example of a wireless communication module of the wireless communication device used as the first example application.

FIG. 15 is a block diagram illustrating a configuration example of a wireless communication device used as a second application example.

FIG. 16 is a block diagram illustrating a configuration example of a wireless communication device used as a third application example.

FIG. 17 is a block diagram illustrating a configuration example of a wireless communication device used as a fourth application example.

### MODE FOR CARRYING OUT THE INVENTION

Modes for carrying out the present technology (hereinafter, referred to as embodiments) will be described below. The description will be given in the following order.
1. First Embodiment (example of shifting from reference position)
2. Second Embodiment (example of shifting from reference position using step information in response signal to polling signal)
3. First Application Example (example in which module other than wireless communication module is provided in wireless communication device)
4. Second Application Example (example in which wireless communication device is applied to smartphone)
5. Third Application Example (example in which wireless communication device is applied to in-vehicle device)
6. Fourth Application Example (example in which wireless communication device is applied to wireless AP including wired communication interface)

### 1. First Embodiment

### Configuration Example of Wireless Communication System

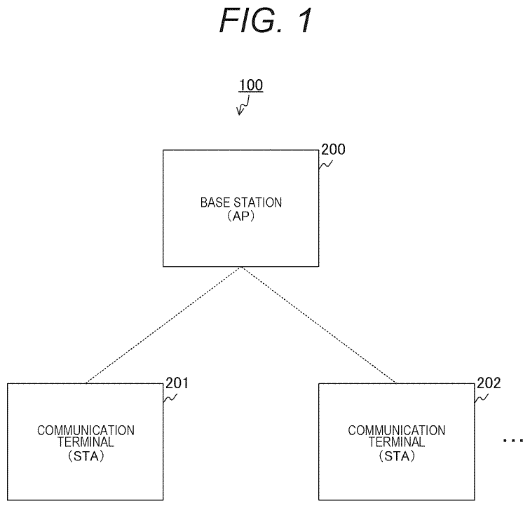

FIG. 1 is a diagram illustrating a configuration example of a wireless communication system 100 according to embodiments of the present technology. The wireless communication system 100 includes a base station 200 and one or more communication terminals such as communication terminals 201 and 202. The wireless communication system 100 is also referred to as a basic service set (BSS).

The base station 200 is a wireless station that performs wireless communication with a communication terminal connected to the same. The base station 200 is also referred to as an access point or a master unit. As a communication standard, IEEE 802.11 standard is used. For example, a next-generation standard of IEEE 802.11be or thereafter is used. Furthermore, a signal from the communication terminal to the base station 200 is referred to as an uplink signal, and a signal from the base station 200 to the communication terminal is referred to as a downlink signal.

The communication terminals 201 and 202 are wireless stations connected to the base station 200 by association processing and the like and perform wireless communication with the base station 200. These communication terminals are also referred to as slave units. Furthermore, while a certain communication terminal is transmitting an uplink signal, another communication terminal can multiplex another uplink signal to the signal by a NOMA system. The multiplexing by the NOMA system is used, for example, when a signal requiring low delay is transmitted.

Hereinafter, an uplink signal that allows multiplexing by the NOMA system is referred to as a “signal subjected to NOMA”, and a communication terminal as a transmission source thereof is referred to as a “terminal subjected to NOMA”. Furthermore, an uplink signal to be multiplexed to the signal subjected to NOMA by the NOMA system is referred to as a “NOMA signal”, and a communication terminal as a transmission source thereof is referred to as a “NOMA terminal”.

### Configuration Example of Communication Terminal

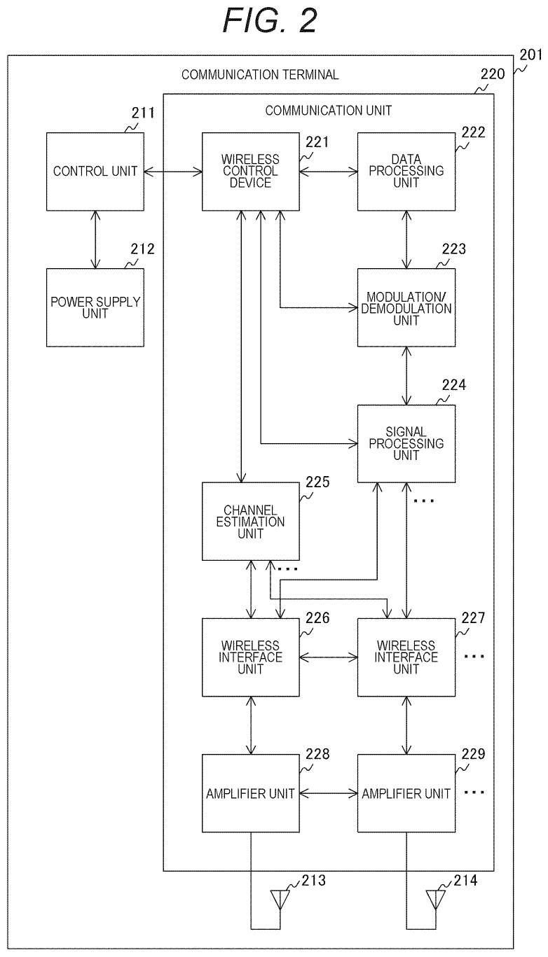

FIG. 2 is a block diagram illustrating a configuration example of the communication terminal 201 according to a first embodiment of the present technology. This communication terminal 201 includes a control unit 211, a power supply unit 212, and a communication unit 220. The communication unit 220 includes a wireless control device 221, a data processing unit 222, a modulation/demodulation unit 223, a signal processing unit 224, a channel estimation unit 225, and one or more antennas such as antennas 213 and 214. Furthermore, the communication unit 220 includes one or more wireless interface units such as wireless interface units 226 and 227 and one or more amplifier units such as amplifier units 228 and 229. The amplifier unit is connected to each of the wireless interface units, and the antenna is connected to each of the amplifier units. Note that, a configuration of each of the base station 200 and the communication terminal 202 is similar to that of the communication terminal 201.

The control unit 211 controls an entire communication terminal 201. The power supply unit 212 includes a battery or a fixed power supply, and supplies power to the communication terminal 201. At least a part of the control unit 211 and the communication unit 220 can be implemented by large scale integration (LSI).

In the communication unit 220, the wireless control device 221 exchanges signals between each unit in the communication unit 220 and the control unit 211. Furthermore, the wireless control device 221 performs packet scheduling in the data processing unit 222, and performs parameter setting and transmission power control of the wireless interface unit and the amplifier unit.

Moreover, in a case where the communication terminal 201 is caused to function as the NOMA terminal, when receiving the downlink signal including reference position information indicating a predetermined reference position from the base station 200, the wireless control device 221 acquires a transmission position of the NOMA signal from the reference position. Here, the reference position is a position used as a reference when the transmission position of the NOMA signal is acquired in at least one of a frequency domain or a time domain. Then, the wireless control device 221 controls the wireless interface unit 226 and the like to transmit the NOMA signal from the transmission position. Therefore, the communication terminal 201 can multiplex the signal by the NOMA system at the transmission position determined by the terminal itself on the basis of the reference position information.

In contrast, in a case where the communication terminal 201 is caused to function as the terminal subjected to NOMA, when receiving the downlink signal including the reference position, the wireless control device 221 transmits the signal subjected to NOMA. A sequence at the time of multiplexing by the NOMA system will be described later in detail.

The data processing unit 222 performs processing in a media access control (MAC) layer. At the time of transmission, the data processing unit 222 performs processing of generating a packet by adding a MAC header, an error detection code and the like to data of an upper layer such as a logical link control (LLC) layer from the wireless control device 221. Then, the data processing unit 222 supplies the processed packet to the modulation/demodulation unit 223.

Furthermore, at the time of reception, the data processing unit 222 executes MAC header analysis, packet error detection, reorder processing and the like for the packet from the modulation/demodulation unit 223, and supplies the processed data to the upper layer via the wireless control device 221.

The modulation/demodulation unit 223 performs modulation and demodulation. At the time of transmission, the modulation/demodulation unit 223 performs encoding, interleaving, and modulation on the packet from the data processing unit 222 on the basis of coding and a modulation system set by the wireless control device 221, and generates a data symbol stream. Then, the modulation/demodulation unit 223 supplies the data symbol stream to the signal processing unit 224.

Furthermore, at the time of reception, the modulation/demodulation unit 223 performs decoding, deinterleaving, and demodulation corresponding to the time of transmission on the data symbol stream from the signal processing unit 224, and supplies the processed packet to the data processing unit 222.

The signal processing unit 224 performs various types of signal processing. At the time of transmission, the signal processing unit 224 performs signal processing provided for spatial separation for the input from the modulation/demodulation unit 223 as necessary, and supplies one or more obtained transmission symbol streams to the wireless interface units 226 and 227.

Furthermore, at the time of reception, the signal processing unit 224 performs signal processing on a reception symbol stream from the wireless interface units 226 and 227, and performs spatial decomposition of the stream as necessary, and supplies the same to the modulation/demodulation unit 223.

Furthermore, at the time of reception, the signal processing unit 224 performs interference cancellation processing on the input from the wireless interface unit, and extracts a desired signal from superimposed signals. In this interference cancellation processing, complex channel gain information from the channel estimation unit 225 is used.

The channel estimation unit 225 calculates the complex channel gain information of a transmission path from a preamble portion and a training signal portion of an input signal from each wireless interface unit. The calculated complex channel gain information is supplied to the modulation/demodulation unit 223 and the signal processing unit 224 and used for spatial processing.

The wireless interface units 226 and 227 convert an analog signal and a digital signal to each other. At the time of transmission, these wireless interface units convert a digital signal from the signal processing unit 224 into an analog signal, perform filtering and up-conversion, and transmit the same to the corresponding amplifier unit.

Furthermore, the wireless interface unit down-converts an analog signal at the time of reception, converts the same into a digital signal, and supplies the same to the channel estimation unit 225 and the signal processing unit 224.

The amplifier units 228 and 229 amplify the analog signal. At the time of transmission, these amplifier units amplify the analog signal from the corresponding wireless interface unit up to predetermined power and supply the same to the corresponding antenna. Furthermore, at the time of reception, the amplifier unit amplifies the analog signal from the corresponding antenna up to predetermined power and supplies the same to the corresponding wireless interface unit.

### Operation Example of Wireless Communication System

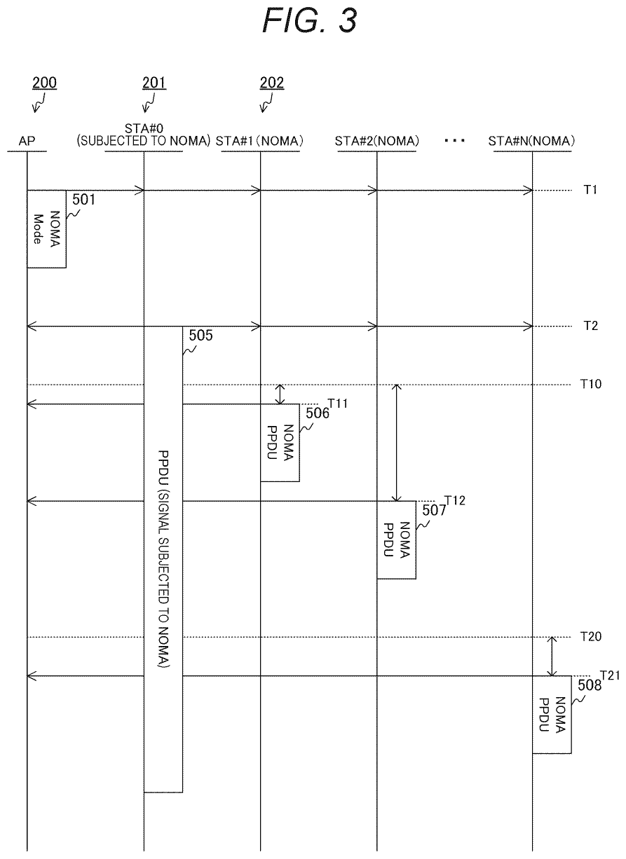

FIG. 3 is a sequence diagram illustrating an example of a communication method of the wireless communication system 100 according to the first embodiment of the present technology. The sequence in the drawing is started when multiplex communication by the NOMA system is performed without arrangement of transmission timing or the like in advance (in other words, asynchronous). Hereinafter, a mode in which the asynchronous multiplex communication is performed is referred to as a “NOMA mode”.

At timing T1, the base station 200 transmits a notification signal 501 for notifying that it shifts to the NOMA mode to each of subordinate communication terminals. Note that, the notification signal 501 can also be transmitted by the base station 200 in response to a request from the communication terminal.

Furthermore, the notification signal 501 includes information indicating the shift to the NOMA mode, information indicating the reference position, and step information indicating a unit when shifting from the reference position in at least one of the frequency domain or the time domain. Specific contents and storing places of these pieces of information will be described later. By transmission of the notification signal 501, the BSS including the base station 200 shifts to the NOMA mode. Note that, a configuration in which the notification signal 501 does not include the step information is also possible. Furthermore, a plurality of reference positions can be stored in the notification signal 501.

The communication terminal transmits the uplink signal (that is, the signal subjected to NOMA) that allows multiplexing by the NOMA system in a case where one or more of the following conditions are satisfied.
(Condition 1) The signal subjected to NOMA has a certain length or longer.
(Condition 2) The signal subjected to NOMA is not a signal required to have high reliability.

Furthermore, while the terminal subjected to NOMA is transmitting the signal subjected to NOMA, the NOMA terminal can transmit the uplink signal (that is, the NOMA signal) to be multiplexed to the signal subjected to NOMA by the NOMA system.

It is assumed that the communication terminal 201 functions as a terminal subjected to NOMA STA #0, and N (N is an integer) communication terminals including the communication terminal 202 function as NOMA terminals STA #1 to STA #N.

From timing T2, the terminal subjected to NOMA STA #0 transmits a signal subjected to NOMA 505 to each of the base station 200 and the NOMA terminal. This signal subjected to NOMA 505 includes information indicating that the signal itself is the signal subjected to NOMA.

Note that, in a case where the notification signal 501 includes the step information and the terminal subjected to NOMA STA #0 wants to change the step information, the terminal subjected to NOMA STA #0 can store the changed step information in the signal subjected to NOMA 505 to transmit. Furthermore, in a case where the notification signal 501 does not include the step information, the terminal subjected to NOMA STA #0 stores the step information in the signal subjected to NOMA 505 to transmit.

In summary, following three cases are conceivable regarding the signal in which the step information is included.
(Case 1) The notification signal 501 includes the step information, and the signal subjected to NOMA 505 does not include the step information.
(Case 2) The notification signal 501 includes the step information before change, and the signal subjected to NOMA 505 includes the changed step information.
(Case 3) The notification signal 501 does not include the step information, and the signal subjected to NOMA 505 includes the step information.

Furthermore, when transmitting the signal subjected to NOMA 505, it is desirable that the terminal subjected to NOMA STA #0 performs processing of enhancing interference resistance on a signal portion that is likely to be multiplexed of the signal subjected to NOMA 505. Examples of the processing of enhancing the interference resistance include the following three, for example.
(Processing 1) A modulation and channel coding scheme (MCS) of a signal portion that is likely to be multiplexed is made lower than that of other portions.
(Processing 2) A part of resource units (RUs) of the signal portion that is likely to be multiplexed is disabled so as not to be used.
(Processing 3) The same data is duplicated in the signal portion that is likely to be multiplexed.

The terminal subjected to NOMA STA #0 may perform only one of these pieces of processing or may perform two or more of them in combination.

While the signal subjected to NOMA 505 is being transmitted, each of the NOMA terminals acquires the transmission position of the NOMA signal from the reference position and the step information. For example, the NOMA terminal generates a pseudo random number, and calculates, as the transmission position, a position shifted from the reference position in the frequency/time domain by a value obtained by multiplying the pseudo random number by the unit indicated by the step information. The pseudo random number is generated by, for example, a linear combination method or a linear feedback shift register.

When a reference position on a time axis is represented by T_{ref}, a pseudo random number is represented by R, and a unit on the time axis indicated by the step information is represented by Tₛₜₑₚ, a transmission position T_{send} on the time axis is calculated by the following expression.

$${T}_{send} = {T}_{ref} + R \times {T}_{step} \qquad [ Expression 1 ]$$

Note that, a method for calculating the transmission position is not limited to expression 1. For example, instead of the pseudo random number generated by the linear combination method or the like, the NOMA terminal can use the number of backoff (BO) remaining counter or an index calculated from an association identifier (AID) as the pseudo random number. The index is calculated, for example, from a remainder obtained by dividing the AID by the number of communication terminals or the like.

A transmission position on a frequency axis is also calculated by similar calculation. Therefore, a position shifted by a random value amount within a predetermined range along at least one of the time axis or the frequency axis is specified as the transmission position. Note that, the notification signal may include range information indicating a range of the transmission position or a range of the pseudo random number R.

It is assumed that the reference positions on the time axis in the notification signal 501 are timings T10 and T20. The NOMA terminal STA #1 calculates timing T11 from the timing T10 by expression 1, and transmits a NOMA signal 506 to the base station 200 over a transmission period from this timing. The NOMA terminal STA #2 calculates timing T12 from the timing T10 by expression 1, and transmits a NOMA signal 507 to the base station 200 from this timing.

Furthermore, the NOMA terminal STA #N calculates timing T21 from the timing T20 by expression 1, and transmits a NOMA signal 508 to the base station 200 over a transmission period from this timing. For example, in a case where the timing T10 has passed at the time when the NOMA terminal STA #N generates the transmission signal, timing T20 is used in expression 1. In a case of receiving the signal subjected to NOMA, the base station 200 performs interference cancellation processing on each of the signal subjected to NOMA and the NOMA signal from each NOMA terminal, detects each signal, and performs decoding processing.

In a case where each of the NOMA terminals transmits the NOMA signal from the same transmission position, even if a random power offset is applied, when multiplexing is performed by the NOMA system, there is a case where signals more than expected are multiplexed and interference increases. In this case, a reception side cannot decode the signal, and retransmission might occur due to reception failure, leading to an increase in delay.

In contrast, in the communication method in the drawing, each of the NOMA terminals acquires the transmission position shifted from the reference position and transmits the NOMA signal, so that it is possible to suppress an increase in interference due to multiplexing of signals more than expected at the time of asynchronous multiplexing. Therefore, occurrence of retransmission due to reception failure can be suppressed. Furthermore, by performing asynchronous communication, it is possible to reduce overhead of signaling for determining signal transmission timing.

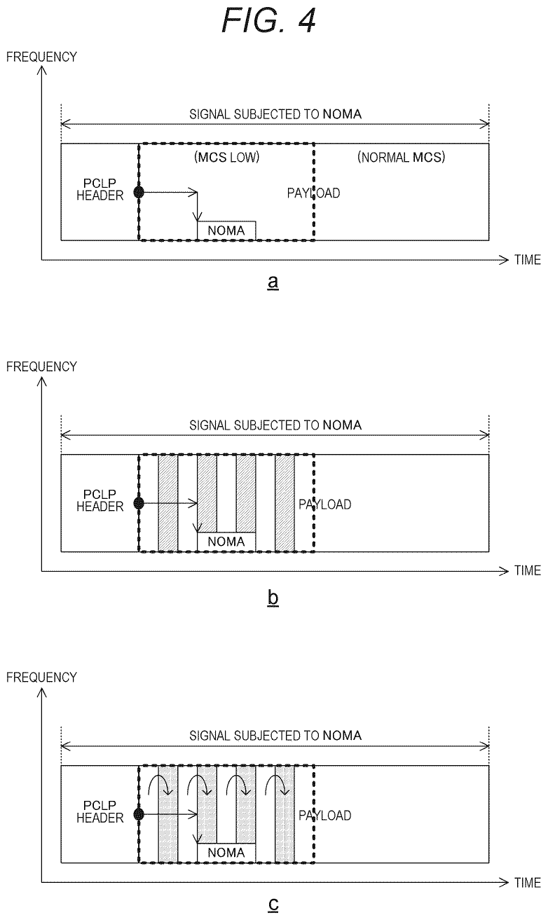

FIG. 4 is a diagram for illustrating a countermeasure against interference according to the first embodiment of the present technology. As described above, it is desirable that the terminal subjected to NOMA STA #0 performs processing of enhancing interference resistance on a signal portion that is likely to be multiplexed out of the signal subjected to NOMA 505.

A vertical axis in a, b, and c of the drawing indicate the frequency, and a horizontal axis indicates the time. Furthermore, a black circle indicates the reference position. Furthermore, an arrow indicates a shifted direction. A rectangular portion in which “NOMA” is written indicates the NOMA signal. A portion surrounded by a dotted line indicates the signal portion to which the NOMA signal is likely to be multiplexed.

As illustrated in a of the drawing, the terminal subjected to NOMA can execute the processing 1 of setting the MCS of the signal portion that is likely to be multiplexed lower than that of other portions. Note that, the terminal subjected to NOMA can also set the MCS of the signal portion that is likely to be multiplexed to be lower than a determined value in communication standards.

Furthermore, as illustrated in b of the drawing, the terminal subjected to NOMA can also perform the processing 2 of disabling a part of the RUs of the signal portion that is likely to be multiplexed so as not to be used. A hatched portion in b of the drawing indicates the disabled RUs.

Furthermore, as illustrated in c of the drawing, the terminal subjected to NOMA can also perform the processing 3 of duplicating the same data in the signal portion that is likely to be multiplexed. A gray portion in c of the drawing is data obtained by duplicating a white portion on a left side thereof.

### Configuration Example of Frame

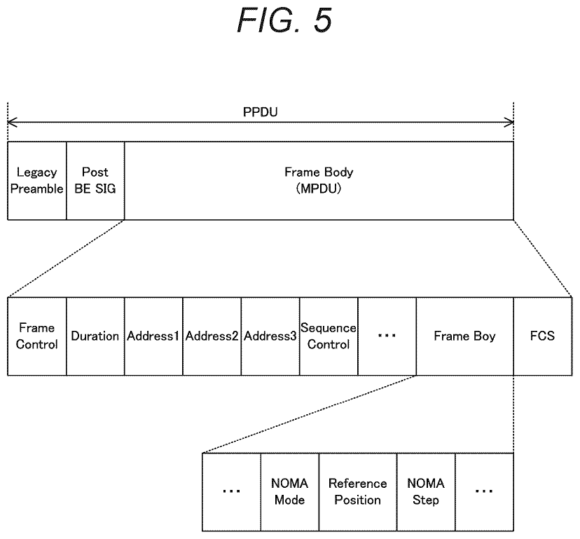

FIG. 5 is a diagram illustrating a configuration example of a frame in the notification signal from the base station 200 according to the first embodiment of the present technology. The notification signal includes a PLCP protocol data unit (PPDU), and the PPDU (that is, a PHY frame) includes a MAC protocol data unit (MPDU). This MPDU (that is, the MAC frame) includes a “Frame Control” field, a “Duration” field, an “Address” field, a “Sequence Control” field, a frame body, a “Frame Check Sequence (FCS)” field and the like. A format of the MPDU depends on the type of communication standard, and may further include a “high throughput (HT) control” field and the like.

The frame body of the MPDU in the notification signal includes a “NOMA Mode” field, a “Reference Position” field, and a “NOMA STEP” field. The “NOMA Mode” field stores information indicating that the wireless communication system 100 shifts to the NOMA mode. This information may be managed by a one-bit flag, or may be defined separately from other NOMA communications. Furthermore, a part (at least one or two) of “NOMA Mode”, “Reference Position”, and “NOMA STEP” and the rest may be transmitted by different MPDUs or PPDUs.

The “Reference Position” field stores the reference position. For example, a head of the packet, a midamble, or a head of the signal (that is, information in payload) is used as the reference position.

The “NOMA STEP” field stores the step information indicating the unit when shifting from the reference position. For example, the step information is defined by a fixed time length and a fixed frequency shift length. As the information of the fixed time length, for example, information designating any of a plurality of predefined time lengths or a multiple with respect to a predefined minimum fixed time length is described. Alternatively, as the information of the fixed time length, a parameter (coefficient or the like) used for operation of calculating the fixed time length from the packet length is described.

Furthermore, as the information of the frequency shift length, information designating a size of a frequency block including a plurality of predefined subcarriers or a multiple with respect to a predefined minimum frequency block is described.

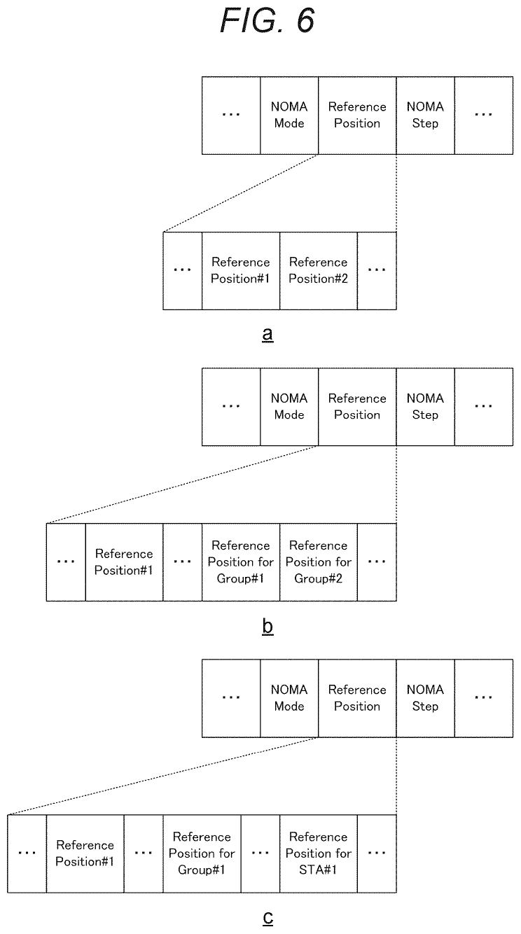

FIG. 6 is a diagram illustrating an example of the reference position in the notification signal according to the first embodiment of the present technology. At least one of the following three types can be stored in the “Reference Position” field.
(Type 1) A reference position common to all communication terminals connected to the base station.
(Type 2) A reference position common to a predetermined number of communication terminals in a predetermined group.
(Type 3) A reference position individually allocated to a predetermined communication terminal.

In a of the drawing, a configuration in which only one type is stored is illustrated, and “Reference Position #1” and “Reference Position #2” indicate the reference positions common to all the communication terminals. Only one common reference position may be stored, or two or more common reference positions may be stored.

In b of the drawing, a configuration in which two types are stored is illustrated, and “Reference Position for Group #1” and “Reference Position for Group #2” indicate the reference positions common to a predetermined number of communication terminals in each group. The number of groups may be one or two or more.

In c of the drawing, a configuration in which three types are stored is illustrated, and “Reference Position for STA #1” indicates the reference position individually allocated to the communication terminal STA #1. The reference position can also be individually allocated to each of two or more communication terminals.

In a case where a plurality of types of reference positions is stored, for example, when there is the reference position individually allocated to each of the communication terminals, each of the communication terminals uses the reference position with highest priority. Furthermore, when there is the reference position of the group to which each of the communication terminals belongs, each of the communication terminals uses the reference position with priority higher than that of the reference position common to all the communication terminals.

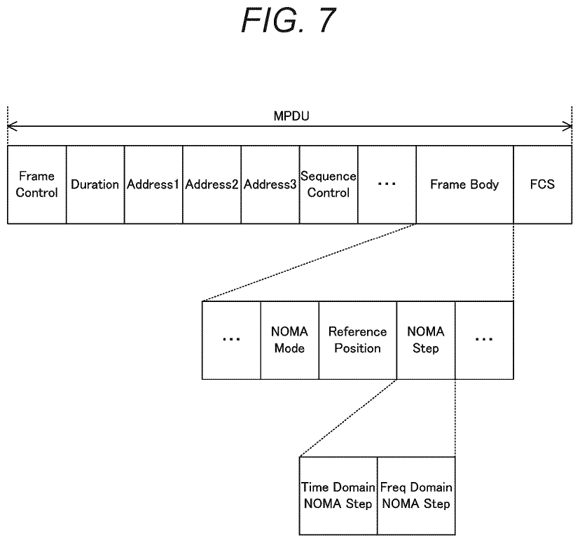

FIG. 7 is a diagram illustrating an example of the step information in the notification signal according to the first embodiment of the present technology. As illustrated in the drawing, the “NOMA STEP” field in the notification signal includes a “Time Domain NOMA STEP” field and a “Freq Domain NOMA STEP” field. The “Time Domain NOMA STEP” field stores information indicating a unit (such as a fixed time length) of shifting from the reference position in the time domain. In the “Freq Domain NOMA STEP” field, information indicating a unit (such as a frequency shift length) of shifting from the reference position in the frequency domain is stored.

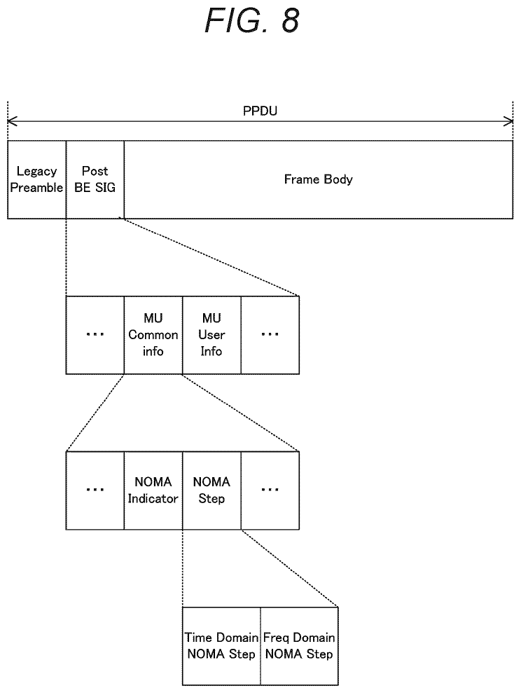

FIG. 8 is a diagram illustrating a configuration example of a frame in the signal subjected to NOMA from the terminal subjected to NOMA according to the first embodiment of the present technology. The signal subjected to NOMA includes a PPDU (PHY frame), and the PPDU includes a “Legacy Preamble” field, a “Post BE SIG” field, and a frame body.

The “Legacy Preamble” field stores a preamble signal used in a previous communication standard. In the “Post BE SIG” field, various pieces of information regarding a signal (SIGNAL) stored in the frame body are stored, and the format thereof is determined by a next-generation communication standard of IEEE 802.11be or thereafter.

For example, the “Post BE SIG” field includes an “MU Common info” field and an “MU User Info” field. In the “MU Common info” field, information common to the communication terminals in the wireless communication system 100 is stored. This field includes, for example, a “NOMA Indicator” field and a “NOMA Step” field.

The “NOMA Indicator” field stores information indicating that the signal is a signal (that is, the signal subjected to NOMA) that allows multiplexing by the NOMA system. The “NOMA Step” field is provided as necessary. For example, in a case where the terminal subjected to NOMA changes the step information, the changed step information is stored in the “NOMA Step” field. Furthermore, in a case where the notification signal from the base station 200 does not include the step information, the terminal subjected to NOMA generates the step information and stores the same in the “NOMA Step” field in the signal subjected to NOMA. Note that, the “NOMA Indicator” and the “NOMA Step” may be transmitted by different MPDUs or PPDUs.

A value indicated by the step information needs to be varied depending on the signal length of the signal subjected to NOMA or an allowable amount of interference based on a signal to interference plus noise ratio (SINR), and in this case, the step information is stored in the signal subjected to NOMA.

In this manner, according to the first embodiment of the present technology, since the NOMA terminal acquires the transmission position from the reference position and transmits the NOMA signal from the transmission position, it is possible to suppress an increase in interference due to multiplexing of signals more than expected. Therefore, occurrence of retransmission due to reception failure can be suppressed.

### First Variation

In the first embodiment described above, the communication terminal shifts from the reference position in both the frequency domain and the time domain, but it is also possible to shift only in one of them. A wireless communication system 100 in a first variation of the first embodiment is different from that of the first embodiment in shifting from a reference position only in a time domain.

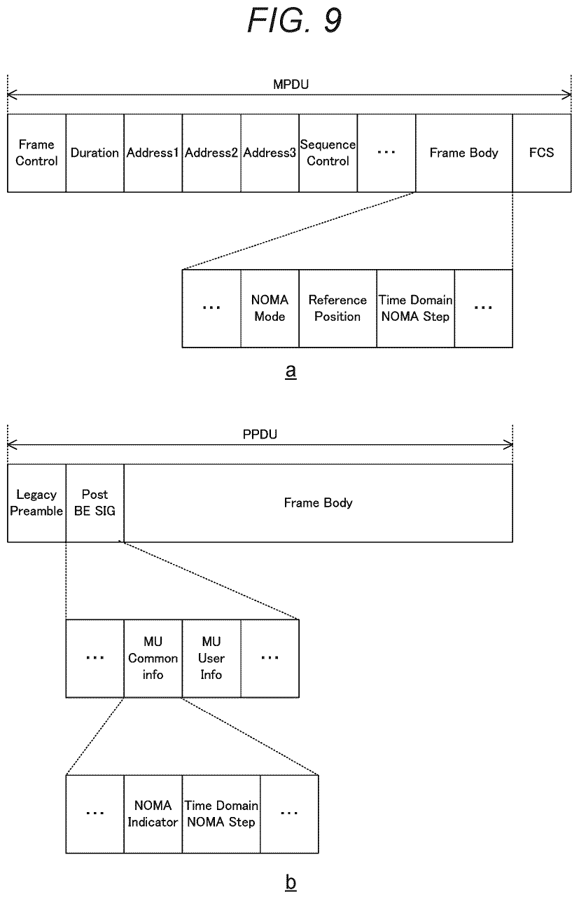

FIG. 9 is a diagram illustrating a configuration example of a frame in a first variation of the first embodiment of the present technology. In a of the drawing, a configuration example of a MAC frame in a notification signal from a base station 200 is illustrated. In b of the drawing, a configuration example of a PHY frame in a signal subjected to NOMA from a terminal subjected to NOMA is illustrated.

As illustrated in a of the drawing, the MAC frame in the notification signal includes a “Time Domain NOMA STEP” field but does not include a “Freq Domain NOMA STEP” field.

Furthermore, as illustrated in b of the drawing, the PHY frame in the signal subjected to NOMA similarly includes the “Time Domain NOMA STEP” field but does not include the “Freq Domain NOMA STEP” field.

In this manner, according to the first variation of the first embodiment of the present technology, since it is shifted from the reference position only in the time domain, it is not necessary to provide the “Freq Domain NOMA STEP” field in the frame.

### Second Variation

In the first embodiment described above, the communication terminal shifts from the reference position in both the frequency domain and the time domain, but it is also possible to shift from the reference position only in one of them. A wireless communication system 100 in a second variation of the first embodiment is different from that of the first embodiment in shifting from a reference position only in a frequency domain.

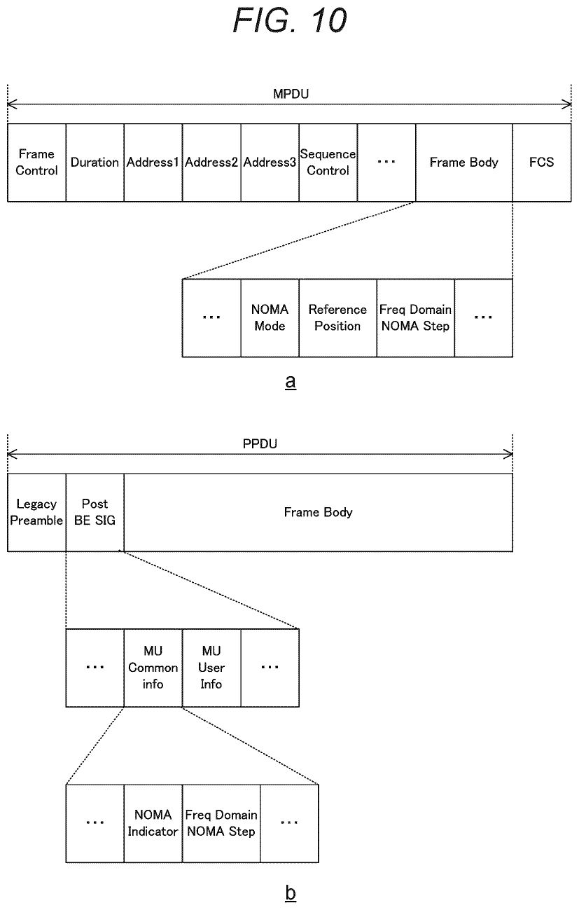

FIG. 10 is a diagram illustrating a configuration example of a frame in a second variation of the first embodiment of the present technology. In a of the drawing, a configuration example of a MAC frame in a notification signal from a base station 200 is illustrated. In b of the drawing, a configuration example of a PHY frame in a signal subjected to NOMA from a terminal subjected to NOMA is illustrated.

As illustrated in a of the drawing, the MAC frame in the notification signal includes a “Freq Domain NOMA STEP” field but does not include a “Time Domain NOMA STEP” field.

Furthermore, as illustrated in b of the drawing, the PHY frame in the signal subjected to NOMA similarly includes the “Freq Domain NOMA STEP” field but does not include the “Time Domain NOMA STEP” field.

In this manner, according to the second variation of the first embodiment of the present technology, since it is shifted from the reference position only in the frequency domain, it is not necessary to provide the “Time Domain NOMA STEP” field in the frame.

### 2. Second Embodiment

In the first embodiment described above, the terminal subjected to NOMA transmits the signal subjected to NOMA to each of the NOMA terminals. However, there is a case where the signal subjected to NOMA reaches the base station 200 but does not reach one or more NOMA terminals because of a shielding object and a distance, so that the terminal becomes a hidden terminal. A wireless communication system 100 of a second embodiment is different from that of the first embodiment in making multiplexing by a NOMA system possible even in a case where a NOMA terminal becomes a hidden terminal.

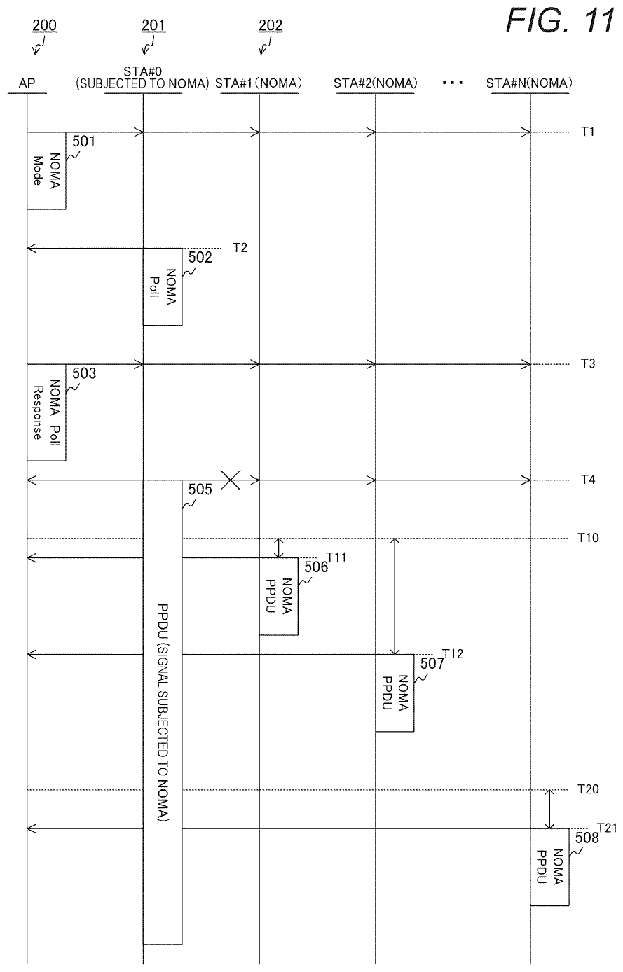

FIG. 11 is a sequence diagram illustrating an example of a communication method of the wireless communication system 100 according to the second embodiment of the present technology.

It is assumed that a signal from a terminal subjected to NOMA STA #0 does not reach a NOMA terminal STA #1, and the NOMA terminal STA #1 becomes a hidden terminal as viewed from the terminal subjected to NOMA STA #0.

When a notification signal 501 is transmitted from a base station 200, the terminal subjected to NOMA STA #0 generates a polling signal 502 at timing T2 and transmits the same to the base station 200. The polling signal includes “NOMA Indicator” and “NOMA Step” illustrated in FIG. 8.

Returning to FIG. 11, the base station 200 extracts step information of “NOMA Step” from the polling signal and stores the same in a response signal 503 to the polling signal. Then, the base station 200 transmits the response signal to each of communication terminals over a transmission period from timing T3.

Then, over a transmission period from timing T4, the terminal subjected to NOMA STA #0 transmits a signal subjected to NOMA 505 to each of the base station 200 and the NOMA terminal. Each of the NOMA terminals extracts the step information from the response signal 503 or the signal subjected to NOMA 505, and acquires a transmission position from the step information.

Although the signal subjected to NOMA from the terminal subjected to NOMA STA #0 does not reach the NOMA terminal STA #1, the response signal 503 from the base station 200 reaches the same, so that the step information can be extracted from the response signal. Therefore, even in a case where the NOMA terminal becomes the hidden terminal, multiplexing by the NOMA system can be performed.

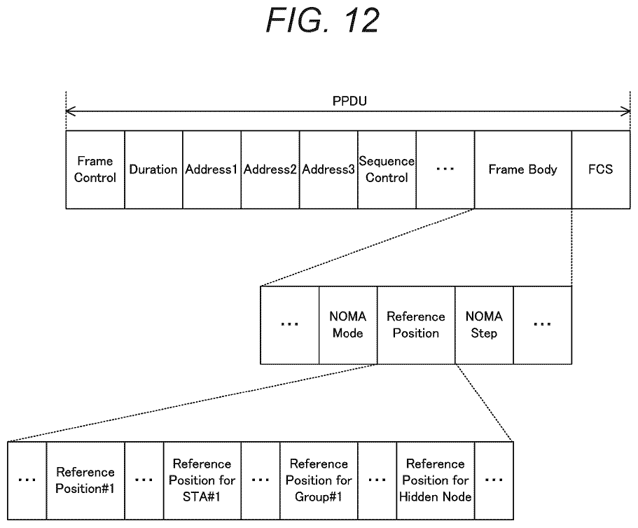

FIG. 12 is a diagram illustrating a configuration example of a notification signal according to the second embodiment of the present technology. In the second embodiment, a “Reference Position” field in the notification signal further includes a “Reference Position for Hidden Node” field as necessary. A reference position allocated to the hidden terminal can be stored in the “Reference Position for Hidden Node” field.

In a case where a plurality of types of reference positions is stored, for example, the hidden terminal to which the reference position in the “Reference Position for Hidden Node” field is allocated uses the reference position with highest priority.

Note that, the first and second variations of the first embodiment can be applied to the second embodiment.

In this manner, according to the second embodiment of the present technology, since the base station 200 transmits the response signal to the polling signal from the terminal subjected to NOMA to each NOMA terminal, even if there is the hidden terminal among the NOMA terminals, multiplexing by the NOMA system can be performed.

### 3. First Application Example

In the above-described first embodiment, the communication unit 220 (communication module or the like) that performs wireless communication is provided in the wireless communication device such as the base station 200, the communication terminal 201, or the communication terminal 202; however, a module other than the communication module can be provided in the wireless communication device.

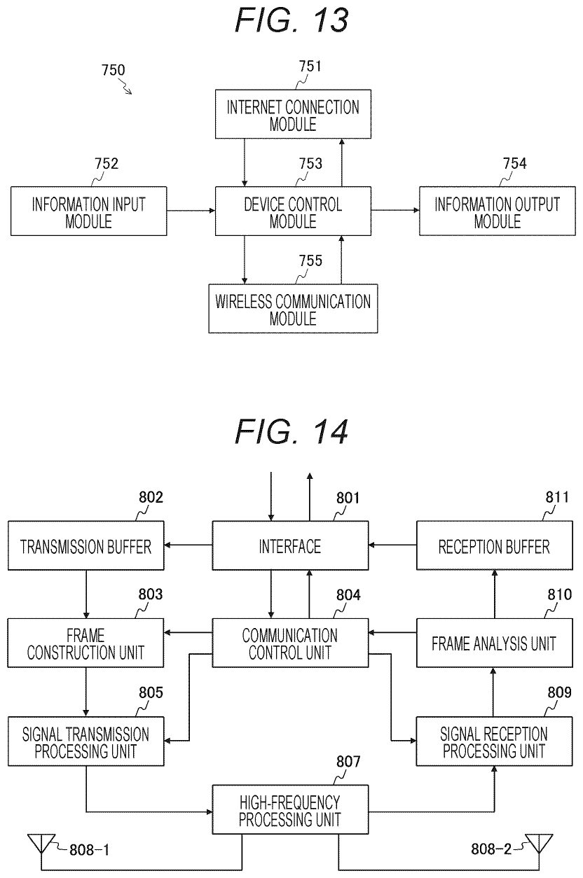

FIG. 13 is a block diagram illustrating a configuration example of a wireless communication device 750 used as a first application example. Note that, the wireless communication device 750 may be any of the base station 200, the communication terminal 201, and the communication terminal 202 described above.

In the drawing, the wireless communication device 750 includes an Internet connection module 751, an information input module 752, a device control module 753, an information output module 754, and a wireless communication module 755. Note that, the wireless communication device 750 may include only necessary modules.

The Internet connection module 751 is configured to implement functions such as a communication modem for connecting to the Internet in a case of operating as an access point (such as the base station 200) according to control of the device control module 753. The Internet connection module 751 connects to the Internet via a public communication line and an Internet service provider.

The information input module 752 outputs information indicating an instruction input by a user to the device control module 753. The information input module 752 includes a push button, a keyboard, a mouse, a touch panel or the like. The information input module 752 may have a voice input function.

The device control module 753 includes a CPU, a read only memory (ROM), a random access memory (RAM) and the like. The device control module 753 executes a program stored in the ROM or the like, and performs control to cause an application to function in a higher layer to operate as an access point or a wireless communication device of a user terminal.

The information output module 754 outputs information regarding an operation state of the wireless communication device 750 or information obtained via the Internet supplied from the device control module 753. The information output module 754 includes a display element such as a light emitting diode (LED), a liquid crystal panel, or an organic display, a speaker that outputs voice and music or the like. The information output module 754 displays and notifies the user of necessary information.

The wireless communication module 755 performs wireless communication to transmit data supplied from the device control module 753 to another wireless communication device. The wireless communication module 755 performs wireless communication to receive data transmitted from another wireless communication device, and outputs the received data to the device control module 753. The wireless communication module 755 may operate as the base station 200 in FIG. 1 or may operate as the communication terminals 201 and 202.

FIG. 14 is a block diagram illustrating a configuration example of the wireless communication module 755 of the wireless communication device 750 used as the first application example. In the drawing, the wireless communication module 755 includes an interface 801, a transmission buffer 802, a frame construction unit 803, a communication control unit 804, and a signal transmission processing unit 805. Furthermore, the wireless communication module 755 includes a high-frequency processing unit 807, antennas 808-1 and 808-2, a signal reception processing unit 809, a frame analysis unit 810, and a reception buffer 811.

The interface 801 functions as an interface for exchanging information input from the user and data supplied from the Internet supplied from the device control module 753 in a predetermined signal format.

The interface 801 outputs the information and data supplied from the device control module 753 to the transmission buffer 802 and the communication control unit 804. The interface 801 outputs information and data supplied from the reception buffer 811 to the device control module 753.

In a case where the transmission buffer 802 receives information input from the user or data to be transmitted, this temporarily stores the received information or data.

In accordance with an instruction from the communication control unit 804, the frame construction unit 803 constructs a data frame or an Ack frame using data accumulated in the transmission buffer 802 or Ack information supplied from the communication control unit 804. The data frame is a MAC layer protocol data unit (MPDU) frame or an aggregated MPDU (A-MPDU) frame, for example. The frame construction unit 803 outputs the constructed frame to the signal transmission processing unit 805.

The communication control unit 804 manages an operation for transmitting and receiving the data and Ack information on the basis of the information supplied from the interface 801 and the frame analysis unit 810. The communication control unit 804 grasps a state of frame construction and data transmission/reception, and controls the frame construction unit 803, the signal transmission processing unit 805, and the signal reception processing unit 809.

The signal transmission processing unit 805 performs encoding processing of the data to be transmitted, and outputs the encoded data to the high-frequency processing unit 807.

The high-frequency processing unit 807 performs predetermined high-frequency processing on the data supplied from the signal transmission processing unit 805, and constructs a signal in each frequency band out of a plurality of frequency bands. The high-frequency processing unit 807 transmits the constructed signal to the wireless communication device of a communication counterpart via the antennas 808-1 and 808-2.

Furthermore, the high-frequency processing unit 807 receives a signal in each frequency band transmitted from the wireless communication device of the communication counterpart via the antennas 808-1 and 808-2, and outputs the received signal to the signal reception processing unit 809.

The signal reception processing unit 809 processes the signal supplied from the high-frequency processing unit 807, and outputs the same to the frame analysis unit 810.

The frame analysis unit 810 extracts a predetermined data frame from the received data, and extracts various types of information and data such as header information, a delimiter, and a payload from the Ack frame. The frame analysis unit 810 outputs the extracted information to the communication control unit 804, and outputs the extracted data to the reception buffer 811.

The reception buffer 811 stores the data supplied from the frame analysis unit 810.

The present technology can be applied to various products. For example, the wireless communication device 750 described above may be implemented as a mobile terminal such as a smartphone, a tablet personal computer (PC), a notebook PC, a portable game terminal, or a digital camera. Furthermore, the wireless communication device 750 described above may be implemented as a fixed terminal such as a television receiver, a printer, a digital scanner, or a network storage, or as an in-vehicle terminal such as a car navigation device. Furthermore, the wireless communication device 750 may be implemented as a machine to machine communication (M2M) terminal such as a smart meter, a vending machine, a remote monitoring device, or a point of sale (POS) terminal. Moreover, the wireless communication device 750 may be a wireless communication module (for example, an integrated circuit module configured by a single die) mounted on these terminals.

In contrast, for example, the wireless communication device 750 may be implemented as an access point (a wireless base station) of a wireless LAN having a router function or not having a router function. Furthermore, the wireless communication device 750 may be implemented as a mobile wireless LAN router. Moreover, the wireless communication device 750 may be a wireless communication module (for example, an integrated circuit module configured by a single die) mounted on these devices.

### 4. Second Application Example

In the first application example described above, the module other than the wireless communication module is provided in the wireless communication device; however, in this second application example, a wireless communication device is applied to a smartphone.

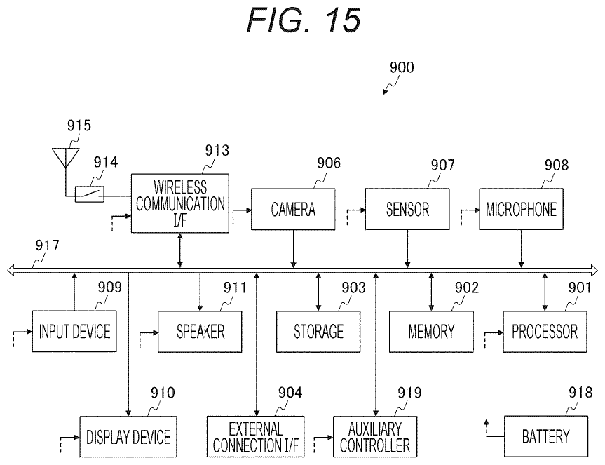

FIG. 15 is a block diagram illustrating a configuration example of the wireless communication device used as the second application example. Note that, a smartphone 900 may be any of the base station 200, the communication terminal 201, and the communication terminal 202 described above.

In the drawing, the smartphone 900 includes a processor 901, a memory 902, a storage 903, an external connection interface 904, a camera 906, a sensor 907, a microphone 908, an input device 909, and a display device 910. Furthermore, the smartphone 900 includes a speaker 911, a wireless communication interface 913, an antenna switch 914, an antenna 915, a bus 917, a battery 918, and an auxiliary controller 919.

The processor 901 may be a CPU or a system on chip (SoC), for example, and limits functions of an application layer and other layers of the smartphone 900.

The memory 902 includes a RAM and a ROM, and stores a program to be executed by the processor 901 and data.

The storage 903 includes a storage medium such as a semiconductor memory or a hard disk.

The external connection interface 904 is an interface for connecting an external device such as a memory card or a universal serial bus (USB) device to the smartphone 900.

The camera 906 includes an imaging element such as, for example, a charge coupled device (CCD) or a complementary metal oxide semiconductor (CMOS), and generates a captured image.

The sensor 907 includes a sensor group including a positioning sensor, a gyro sensor, a geomagnetic sensor, and an acceleration sensor, for example.

The microphone 908 converts voice input to the smartphone 900 into a voice signal.

The input device 909 includes, for example, a touch sensor that detects a touch on a screen of the display device 910, a keypad, a keyboard, a button, a switch or the like, and receives an operation or information input from the user.

The display device 910 includes a screen such as a liquid crystal display (LCD) or an organic light emitting diode (OLED) display, and converts a voice signal output from the smartphone 900 into voice.

The wireless communication interface 913 supports one or more of wireless LAN standards such as IEEE 802.11a, 11b, 11g, 11ac, and 11ad, and executes wireless communication.

The wireless communication interface 913 communicates with other devices via an access point of a wireless LAN in an infrastructure mode. Furthermore, the wireless communication interface 913 directly communicates with other devices in an ad hoc mode or a direct communication mode such as Wi-Fi Direct.

Note that, in Wi-Fi Direct, one of two terminals operates as an access point unlike in the ad-hoc mode, but communication is directly performed between the terminals.

The wireless communication interface 913 typically includes a baseband processor, a radio frequency (RF) circuit, a power amplifier and the like. The wireless communication interface 913 may be a one-chip module in which a memory that stores a communication control program, a processor that executes the program, and related circuits are integrated.

In addition to the wireless LAN system, the wireless communication interface 913 may support other types of wireless communication systems such as a near field wireless communication system, a proximity wireless communication system, or a cellular communication system.

The antenna switch 914 switches a connection destination of the antenna 915 among a plurality of circuits (for example, circuits for different wireless communication systems) included in the wireless communication interface 913.

The antenna 915 includes a single or a plurality of antenna elements (for example, a plurality of antenna elements forming a multiple input multiple output (MIMO) antenna), and is used for transmission and reception of wireless signals by the wireless communication interface 913.

Note that, the smartphone 900 is not limited to the example in FIG. 15, and may include a plurality of antennas (for example, an antenna for a wireless LAN, an antenna of a proximity wireless communication system and the like). In that case, the antenna switch 914 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 913, and the auxiliary controller 919 to one another.

The battery 918 supplies power to each block of the smartphone 900 illustrated in FIG. 15 via a power supply line partially indicated by a dashed line in the drawing.

The auxiliary controller 919 operates minimum necessary functions of the smartphone 900 in a sleep mode, for example. In the smartphone 900, the communication unit 220 illustrated in FIG. 2 may be implemented in the wireless communication interface 913. Furthermore, at least some of these functions may be implemented in the processor 901 or the auxiliary controller 919.

Note that, the smartphone 900 may also operate as a wireless access point (software access point) when the processor 901 executes an access point function at an application level. Furthermore, the wireless communication interface 913 may have a wireless access point function.

Furthermore, the smartphone 900 may operate as a wireless relay device (software relay device) when the processor 901 executes a relay function at an application level.

Moreover, the smartphone 900 may include a biometric authentication unit (fingerprint authentication, palm-shape authentication, voice authentication, blood vessel authentication, face authentication, iris authentication, and retina authentication). At that time, the wireless communication interface 913 in which the communication unit 220 illustrated in FIG. 2 is implemented may be configured to receive power supply from the same battery 918 as that of at least one of the display device 910, the speaker 911, or the biometric authentication unit.

Furthermore, in the smartphone 900, information is displayed from at least one of the display device 910 or the speaker 911 on the basis of communication with an external device by the wireless communication interface 913. At that time, a result of synchronization according to the present technology may be output as information from at least one of the display device 910 or the speaker 911.

### 5. Third Application Example

In the second application example described above, the wireless communication device is applied to the smartphone; however, in this third application example, a wireless communication device is applied to an in-vehicle device.

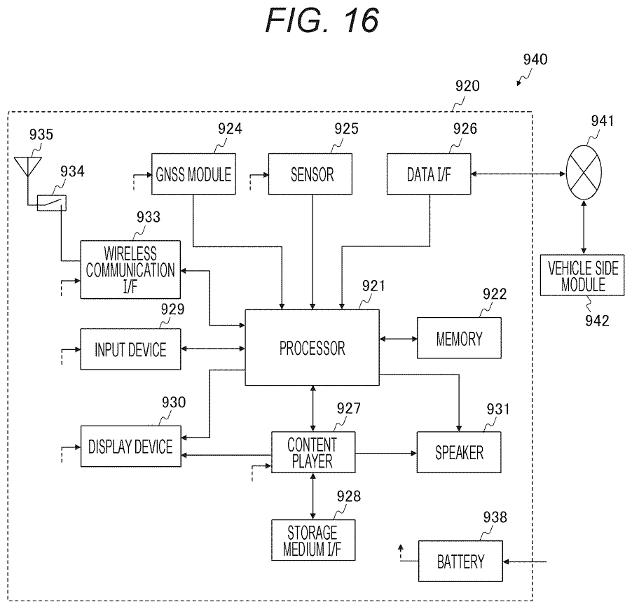

FIG. 16 is a block diagram illustrating a configuration example of the wireless communication device used as the third application example. Note that, the wireless communication device may be any of the base station 200, the communication terminal 201, and the communication terminal 202 described above.

In the drawing, an in-vehicle device 920 includes a processor 921, a memory 922, a global navigation satellite system (GNSS) module 924, a sensor 925, a data interface 926, and a content player 927. Furthermore, the in-vehicle device 920 includes a storage medium interface 928, an input device 929, a display device 930, a speaker 931, a wireless communication interface 933, an antenna switch 934, an antenna 935, and a battery 938.

The processor 921 may be a CPU or an SoC, for example, and controls a navigation function and other functions of the in-vehicle device 920. Furthermore, the processor 921 can also control a drive system of a vehicle, such as a brake, an accelerator, or a steering, on the basis of information obtained through communication based on the present technology.

The memory 922 includes a RAM and a ROM, and stores a program to be executed by the processor 921 and data.

The GNSS module 924 uses a GNSS signal received from a GNSS satellite to measure a location (for example, latitude, longitude, and altitude) of the in-vehicle device 920.

The sensor 925 includes a sensor group including a gyro sensor, a geomagnetic sensor, and an air pressure sensor, for example.

The data interface 926 is connected to an in-vehicle network 941 via, for example, a terminal not illustrated, and acquires data generated on a vehicle side, such as in-vehicle data.

The content player 927 reproduces contents stored in a storage medium (for example, a compact disc (CD) or a digital versatile disc (DVD)) inserted into the storage medium interface 928.

The input device 929 includes, for example, a touch sensor that detects a touch on a screen of the display device 930, a button, a switch or the like, and receives an operation or information input from the user.

The display device 930 includes a screen such as an LCD or an OLED display, and displays an image of a navigation function or reproduced contents.

The speaker 931 outputs voice of the navigation function or the contents to be reproduced.

Note that, in the in-vehicle device 920, the navigation function and the function of the content player 927 are optional. The navigation function and the content player 927 may be removed from the configuration of the in-vehicle device 920.

The wireless communication interface 933 supports one or more of wireless LAN standards such as IEEE 802.11a, 11b, 11g, 11n, 11ac, and 11ad, and executes wireless communication. The wireless communication interface 933 communicates with other devices via an access point of a wireless LAN in an infrastructure mode. Furthermore, the wireless communication interface 933 directly communicates with other devices in an ad hoc mode or a direct communication mode such as Wi-Fi Direct.

The wireless communication interface 933 typically includes a baseband processor, an RF circuit, a power amplifier and the like. The wireless communication interface 933 may be a one-chip module in which a memory that stores a communication control program, a processor that executes the program, and related circuits are integrated. In addition to the wireless LAN system, the wireless communication interface 933 may support other types of wireless communication systems such as a near field wireless communication system, a proximity wireless communication system, or a cellular communication system.

The antenna switch 934 switches a connection destination of the antenna 935 among a plurality of circuits included in the wireless communication interface 933.

The antenna 935 includes a single or a plurality of antenna elements, and is used for transmission and reception of wireless signals by the wireless communication interface 933.

Note that, the in-vehicle device 920 is not limited to the example in FIG. 16, and may include a plurality of the antennas 935. In that case, the antenna switch 934 may be omitted from the configuration of the in-vehicle device 920.

The battery 938 via a power supply line partially indicated by a dashed line in the drawing. In the in-vehicle device 920 illustrated in FIG. 16, the communication unit 220 illustrated in FIG. 2 may be implemented in the wireless communication interface 933. Furthermore, at least some of these functions may be implemented in the processor 921.

Furthermore, the wireless communication interface 933 may operate as the wireless communication device 750 described above, and provide wireless connection to a terminal possessed by a user in the vehicle.

Furthermore, the present technology may be implemented as an in-vehicle system (or vehicle) 940 including one or more blocks of the in-vehicle device 920 described above, the in-vehicle network 941, and a vehicle-side module 942. The vehicle-side module 942 generates vehicle-side data such as a vehicle speed, an engine speed, or failure information, and outputs the generated data to the in-vehicle network 941.

### 6. Fourth Application Example

In the second application example described above, the wireless communication device is applied to the smartphone; however, in this fourth application example, this is applied to a wireless communication device 950 including a wired communication interface.

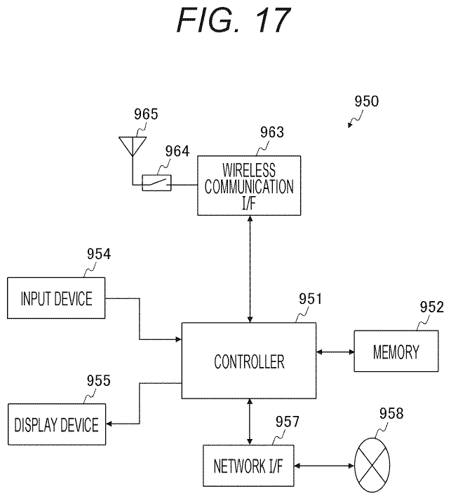

FIG. 17 is a block diagram illustrating a configuration example of a wireless access point 950 (wireless communication device) used as the fourth application example. Note that, this wireless communication device is used as the base station 200 described above.

In the drawing, the wireless access point 950 includes a controller 951, a memory 952, an input device 954, a display device 955, a network interface 957, a wireless communication interface 963, an antenna switch 964, and an antenna 965.

The controller 951 may be a CPU or a digital signal processor (DSP), for example. The controller 951 operates various functions (for example, access restriction, routing, encryption, firewall and log management and the like) of the Internet Protocol (IP) layer and higher layers of the wireless access point 950.

The memory 952 includes a RAM and a ROM, and stores a program to be executed by the controller 951 and various control data (for example, a terminal list, a routing table, an encryption key, a security setting, a log and the like).

The input device 954 includes, for example, a button, a switch and the like, and receives an operation from the user.

The display device 955 includes an LED lamp and the like, and displays an operation status of the wireless access point 950.

The network interface 957 is a wired communication interface for the wireless access point 950 to connect to a wired communication network 958. The network interface 957 may include a plurality of connecting terminals. The wired communication network 958 may be a LAN such as Ethernet (registered trademark), or may be a WAN.

The wireless communication interface 963 supports one or more of the wireless LAN standards such as IEEE 802.11a, 11b, 11g, 11n, 11ac, and 11ad, and provides wireless connection as the access point to a terminal in its vicinity.

The wireless communication interface 963 typically includes a baseband processor, an RF circuit, a power amplifier and the like.

The wireless communication interface 963 may be a one-chip module in which a memory that stores a communication control program, a processor that executes the program, and related circuits are integrated.

The antenna switch 964 switches a connection destination of the antenna 965 among a plurality of circuits included in the wireless communication interface 963.

The antenna 965 includes a single or a plurality of antenna elements, and is used for transmission and reception of wireless signals by the wireless communication interface 963.

In the wireless access point 950 illustrated in FIG. 17, the communication unit 220 illustrated in FIG. 2 may be implemented in the wireless communication interface 963. Furthermore, at least some of these functions may be implemented in the controller 951.

Note that, the embodiments described above describe an example for embodying the present technology, and the matters in the embodiments and the matters specifying the invention in claims have a correspondence relationship. Similarly, the matters specifying the invention in claims and the matters with the same names in the embodiments of the present technology have correspondence relationships. However, the present technology is not limited to the embodiments and can be embodied by making various modifications to the embodiments without departing from the gist thereof.

Note that, the effects described in the present specification are merely examples and are not limited, and other effects may also be achieved.

Note that, the present technology may also have the following configuration.
(1) A wireless control device including:
a control unit that determines a transmission position in at least one of a frequency domain or a time domain of a NOMA signal multiplexed to a signal subjected to NOMA by a non-orthogonal multiple access (NOMA) system on the basis of a random value.
(2) The wireless control device according to (1) described above, in which
the control unit acquires reference position information indicating a predetermined reference position in at least one of a frequency domain or a time domain included in a signal transmitted from another wireless device, and determines the transmission position on the basis of the reference position information.
(3) The wireless control device according to (1) described above, in which
the control unit determines, as the transmission position, a position shifted from the reference position by an amount based on the random value along at least one of a time axis or a frequency axis.
(4) The wireless control device according to (2) described above, in which
the control unit determines, as the transmission position, a position shifted by an amount based on a random value within a predetermined range along at least one of a time axis or a frequency axis.
(5) The wireless control device according to (4) described above, in which
the signal includes range information indicating the range.
(6) The wireless control device according to any one of (2) to (5) described above, in which
the signal includes information indicating a mode in which communication of the NOMA system is performed.
(7) The wireless control device according to any one of (2) to (5) described above, in which
the signal subjected to NOMA includes information indicating that multiplexing to the signal by the NOMA system is allowed.
(8) The wireless control device according to (2) described above, in which
the signal includes step information indicating a unit of shifting from the reference position.
(9) The wireless control device according to any one of (2) to (8) described above, in which
the signal subjected to NOMA includes step information indicating a unit of shifting from the reference position.
(10) The wireless control device according to (2) described above, in which
the another wireless device is a base station, and
the signal is a response signal of the base station to a predetermined polling signal.
(11) The wireless control device according to any one of (1) to (10) described above, in which
the reference position includes a reference position common to all communication terminals connected to the base station.
(12) The wireless control device according to any one of (1) to (11) described above, in which
the reference position includes a reference position common to a predetermined number of communication terminals in a predetermined group.
(13) The wireless control device according to any one of (1) to (12) described above, in which
the reference position includes a reference position individually allocated to a predetermined communication terminal.
(14) The wireless control device according to any one of (1) to (13) described above, in which
the reference position includes a reference position allocated to a hidden terminal to which the signal subjected to NOMA does not reach.
(15) A wireless communication system including:
a first communication terminal that transmits a predetermined signal subjected to NOMA; and
a second communication terminal including a control unit that determines a transmission position in at least one of a frequency domain or a time domain of a NOMA signal multiplexed to the signal subjected to NOMA by a NOMA system on the basis of a random value.
(16) A program for causing a computer to execute a control procedure of determining, on the basis of a random value, a transmission position in at least one of a frequency domain or a time domain of a NOMA signal multiplexed to a signal subjected to NOMA by a NOMA system.
(17) A method for controlling a wireless control device including: a control procedure of determining, on the basis of a random value, a transmission position in at least one of a frequency domain or a time domain of a NOMA signal multiplexed to a signal subjected to NOMA by a NOMA system.
(18) A base station that transmits a signal including step information indicating a unit of shifting from a predetermined reference position in at least one of a frequency domain or a time domain for determining a transmission position in at least one of the frequency domain or the time domain of a NOMA signal multiplexed to a signal subjected to NOMA by a NOMA system.
(19) A base station that transmits a signal including reference position information indicating a predetermined reference position in at least one of a frequency domain or a time domain.
(20) The base station according to (19) described above, in which the signal further includes step information indicating a unit of shifting from the reference position.
(21) The base station according to (19) or (20) described above, in which
the signal is a response signal of the base station to a predetermined polling signal.
(22) A wireless control device including: a control unit that transmits, to a base station, a signal including step information indicating a unit of shifting from a predetermined reference position in at least one of a frequency domain or a time domain.
(23) The wireless control device according to (22) described above, in which
the control unit performs control to transmit a signal subjected to NOMA.
(24) The wireless control device according to (22) or (23) described above, in which
the signal subjected to NOMA includes information indicating that multiplexing to the signal by a NOMA system is allowed.
(25) The wireless control device according to any one of (22) to (24) described above, in which
the signal is a polling signal transmitted to the base station.
(26) The wireless control device according to any one of (23) to (25) described above, in which
the control unit sets a modulation and channel coding scheme (MCS) to be lower than a predetermined value for a signal portion that is likely to be multiplexed in the signal subjected to NOMA in a case of transmitting the signal subjected to NOMA.
(27) The wireless control device according to any one of (23) to (26) described above, in which
the control unit disables a part of resource units (RUs) of a signal portion that is likely to be multiplexed in the signal subjected to NOMA in a case of transmitting the signal subjected to NOMA.
(28) The wireless control device according to any one of (23) to (27) described above, in which
the control unit duplicates the same data in a signal portion that is likely to be multiplexed in the signal subjected to NOMA in a case of transmitting the signal subjected to NOMA.

### REFERENCE SIGNS LIST

100 Wireless communication system
200 Base station
201, 202 Communication terminal
211 Control unit
212 Power supply unit
213, 214 Antenna
220 Communication unit
221 Wireless control device
222 Data processing unit
223 Modulation/demodulation unit
224 Signal processing unit
225 Channel estimation unit
226, 227 Wireless interface unit
228, 229 Amplifier unit

1. A wireless control device comprising:
a control unit that determines a transmission position in at least one of a frequency domain or a time domain of a NOMA signal multiplexed to a signal subjected to NOMA by a non-orthogonal multiple access (NOMA) system on a basis of a random value.

2. The wireless control device according to claim 1, wherein
the control unit acquires reference position information indicating a predetermined reference position in at least one of a frequency domain or a time domain included in a signal transmitted from another wireless device, and determines the transmission position on a basis of the reference position information.

3. The wireless control device according to claim 1, wherein
the control unit determines, as the transmission position, a position shifted from the reference position by an amount based on the random value along at least one of a time axis or a frequency axis.

4. The wireless control device according to claim 2, wherein
the control unit determines, as the transmission position, a position shifted by an amount based on a random value within a predetermined range along at least one of a time axis or a frequency axis.

5. The wireless control device according to claim 4, wherein
the signal includes range information indicating the range.

6. The wireless control device according to claim 2, wherein
the signal includes information indicating a mode in which communication of the NOMA system is performed.

7. The wireless control device according to claim 2, wherein
the signal subjected to NOMA includes information indicating that multiplexing to the signal by the NOMA system is allowed.

8. The wireless control device according to claim 2, wherein
the signal includes step information indicating a unit of shifting from the reference position.

9. The wireless control device according to claim 2, wherein
the signal subjected to NOMA includes step information indicating a unit of shifting from the reference position.

10. The wireless control device according to claim 2, wherein
the another wireless device is a base station, and the signal is a response signal of the base station to a predetermined polling signal.

11. The wireless control device according to claim 2, wherein
the reference position includes a reference position common to all communication terminals connected to the base station.

12. The wireless control device according to claim 2, wherein
the reference position includes a reference position common to a predetermined number of communication terminals in a predetermined group.

13. The wireless control device according to claim 2, wherein
the reference position includes a reference position individually allocated to a predetermined communication terminal.

14. The wireless control device according to claim 2, wherein
the reference position includes a reference position allocated to a hidden terminal to which the signal subjected to NOMA does not reach.

15. A wireless communication system comprising:
a first communication terminal that transmits a predetermined signal subjected to NOMA; and
a second communication terminal including a control unit that determines a transmission position in at least one of a frequency domain or a time domain of a NOMA signal multiplexed to the signal subjected to NOMA by a NOMA system on a basis of a random value.

16. A program for causing a computer to execute a control procedure of determining, on a basis of a random value, a transmission position in at least one of a frequency domain or a time domain of a NOMA signal multiplexed to a signal subjected to NOMA by a NOMA system.

17. A method for controlling a wireless control device comprising: a control procedure of determining, on a basis of a random value, a transmission position in at least one of a frequency domain or a time domain of a NOMA signal multiplexed to a signal subjected to NOMA by a NOMA system.
